(19) United States
(12) Patent Application Publication
(10) Pub. No.: US 2013/0020451 A1
(43) Pub. Date: Jan. 24, 2013

(54) Interactive Visual Display System

(71) Applicants: Michael O'Reilly, Los Altos, CA (US); Gregory W. Pronko, Auburn, CA (US)

(72) Inventors: Michael O'Reilly, Los Altos, CA (US); Gregory W. Pronko, Auburn, CA (US)

(73) Assignee: Level 2 Industries, LLC, San Francisco, CA (US)

(21) Appl. No.: 13/554,849

(22) Filed: Jul. 20, 2012

Related U.S. Application Data
(60) Provisional application No. 61/510,444, filed on Jul. 21, 2011.

(51) Int. Cl. F16M 13/02; B23P 17/00

(52) U.S. Cl. 248/205.3; 29/592.1

(57) ABSTRACT

An apparatus base is affixed by adhesive to a surface. The adhesive base may include a release ply and optional carrier. The base, made of a flexible film or more rigid material, is associated with fastener elements. The fasteners may be any of threaded bolt, post, boss, socket element (male or female threaded, or otherwise configured), “snap” connections or the like. The fasteners are received by a display housing frame. A visual display received within the housing may comprise an interactive touchscreen device or other electronic hardware.

### CROSS-REFERENCE TO RELATED APPLICATIONS

This filing claims the benefit of U.S. Provisional Patent Application No. 61/510,444 filed Jul. 21, 2011 with the same title above and incorporated by reference herein in its entirety.

### BACKGROUND

A system is provided for mounting a visual display device, such as a touch screen interface unit (as in an Apple iPad, a Samsung Galaxy Tab, an Archos 101 internet tablet or custom device). The system may be used in conjunction with product sales or advertisement, interactive customer support, product Q&A, and the like.

Certainly, means exist for window-mounting any number of objects. Suction cups, double-stick adhesive, etc. is commonly used for such mounting. However, known approaches suffer various drawbacks. The drawbacks range from the aesthetic to the functional or present a combination of problematic features.

Both suction cups and adhesive tape can lose adhesion and drop the supported object. Such a result is clearly not acceptable when vertically mounting electronics. Suction cups are also ungainly to look at through a storefront window, and also occupy substantial space (in each of depth and surface area coverage).

Certain configurations of double-stick film and foam mounting tapes may offer better options. However, limitations in strength due to application and/or unacceptable difficulty with clean-up when removal is desired are problems that can be avoided.

### SUMMARY

Accordingly, inventive variations described herein provide means for visual display mounting addressing some or all of the noted problems. As will be apparent upon review of the subject Specification, the various embodiments herein address a here-to-fore unmet need in mounting relatively bulky objects in effective fashion.

In one embodiment, an apparatus base is affixed by adhesive to a surface. For vertical mounting, the surface may be a window. Of course, mounting to horizontal surfaces is also contemplated (such as a table, rack, associated bracketing, and the like) and also to orient the display angle to the intended viewer or user.

The adhesive base preferably (though not necessarily) includes a release ply and optional carrier. The carrier may assist in affixing the base “sticker” without bubbles, wrinkles, etc.

The base may comprise 3M CONTROLTAC graphic film. This durable, dimensionally stable, vinyl film offers positionable, pressure activated adhesive (permanent, changeable, or removable) that allows it to be repositioned on the application surface during installation. Channels allow trapped air to escape, which reduces air bubbles that typically occur as large format graphics are installed. Alternatively, an adhesive film base can be provided as tape in a roil form.

The base—made of a flexible film (as above) or more rigid material (executed in thick or reinforced plastic or metal)—is associated with fastener elements (or features). These may be any of a threaded bolt, post, boss, socket element (male or female threaded, or otherwise configured), “snap” connections, Velcro, 3M button “Dual Lock” fasteners and the like.

These elements are received by a display housing frame. Such receipt may be in the form of through holes for bolts or pockets for nuts, snap connection, etc. In any case, the fastener element(s) facilitate securing the base to the frame. The fasteners may be provided in connection with brackets/runners or bosses adhered to the base or they may be integral to the base. VHB tape supplied by 3M is a suitable adhesive for bracket/runner application purpose. In another approach, the mounting brackets are provided in the form of clear PET block heat-melt threaded inserts. These may be solvent or otherwise welded to the base material in order to keep the materials clear for benefits in back-lighting applications. The fastener (or securing) elements may be threaded into the base and any optional mounting features or it may be, snapped, adhered or otherwise configured.

The base, bracket, frame, etc. may comprise machined or injection molded plastic (PET, ABS, Delrin, etc.) or other suitable material. The fastener elements advantageously comprise metal—such as brass or steel for strength. Still, clear plastic fasteners may be desired as per above.

Regarding strength, systems configured for vertical mounting can support as much weight as one would want a window to bear. Because the base can have a very large surface area (e.g., easily 100 cm square or more), excellent strength can be achieved. Such strength is particularly evident in shear. Whereas, the whole base (e.g., when provided as a flexible “sticker”) can be peeled off by starting at a corner when desired for removal.

Yet, in spite of the large surface area available for mounting, in variations where the base is translucent, the “real estate” from a coverage perspective comes at no cost. In the subject devices, the display of the visual device is seen through the mounting base. In this manner, the overall device can be mounted inside a storefront, etc. and the user can view and/or interact with the device from the outside.

In one aspect, this affixation approach acts as an anti-theft measure. That is, the device is inside, but the display is provided outside—a useful feature when electronics are left unattended.

Also, the display device frame is typically rigid and securely encases (while leaving the touch-screen accessible) the display device. Thus secured to the adhered base because the frame does not flex to any substantial degree, it cannot be “peeled” off and taken away with the display device. The same applies for any rigid base associated with the housing through an intermediate bracket, etc. As such, removal is made (at least largely) tool- and time-dependent, stymieing any quick grab-and-go without breaking glass, ripping out shelving, etc.

Another benefit of an embodiment of the affixation approach derives from the use of a base member that includes translucent and opaque sections. Namely, the opaque sections can serve as a visual frame or framing element to a central body. The opaque graphics can then obscure or hide included fastener elements from view. Moreover, the graphics (thus, the base) may be oversized relative to the frame to provide additional framing or other graphic messaging.

Such an approach is not merely aesthetic in quality. Rather, it may be enabling to the device in terms of its intended use as a display for advertising, etc. Namely a “finished” or “polished” approach is required for a device to be effective in advertizing. Stated otherwise, a “kludgy” approach (e.g., as in the use of suction cups evident for mounting display hardware) is simply not acceptable in many contexts.

Furthermore, the frame (e.g., when white, silvered, etc.) can be useful for reflecting radiation and assist in cooling or maintaining reduced temperature for associated hardware (including batteries and electronics). Heat sink elements (e.g., aluminum fin structures) can also or alternatively be incorporated in the frame.

Other optional features associated with the construction of the subject devices include frame covers. These may be snap fit or otherwise affixed after fastener connection. They may “finish” and/or offer further security for the device by enclosing any included electronics.

Also contemplated is a unique string-lighting approach associated with the frame elements. Although shown implemented with a location pin symbol, it may be executed in any shape such as a circle, square, polygon, or otherwise. Any such lighting where a string of lights is entrained within a channel formed in a translucent carrier may offer a bright consistent field of lighting using point lights—without resort to fluorescent or other gas light (e.g., neon) tubes. These point lights may be incandescent or based on light emitting diodes (LEDs).

In addition, methods described herein form part of the subject inventions. These methods include those of manufacture—such as in assembly of the lighting systems above—and/or regarding installation of the subject systems. Further details in regard to such methods are provided below.

### BRIEF DESCRIPTION OF THE DRAWINGS

The figures provided herein may be diagrammatic and are not necessarily drawn to scale, with some components and features exaggerated for clarity. Variations of the inventive subject matter from the examples pictured are contemplated. Depiction of aspects and elements of the inventions in the figures are not intended to limit the scope. However, the content of the figures may serve as the basis for claim limitations—as originally presented or as introduced by amendment. Even so, no claim is made to the trade name of any company and/or any associated trademark or tradedress.

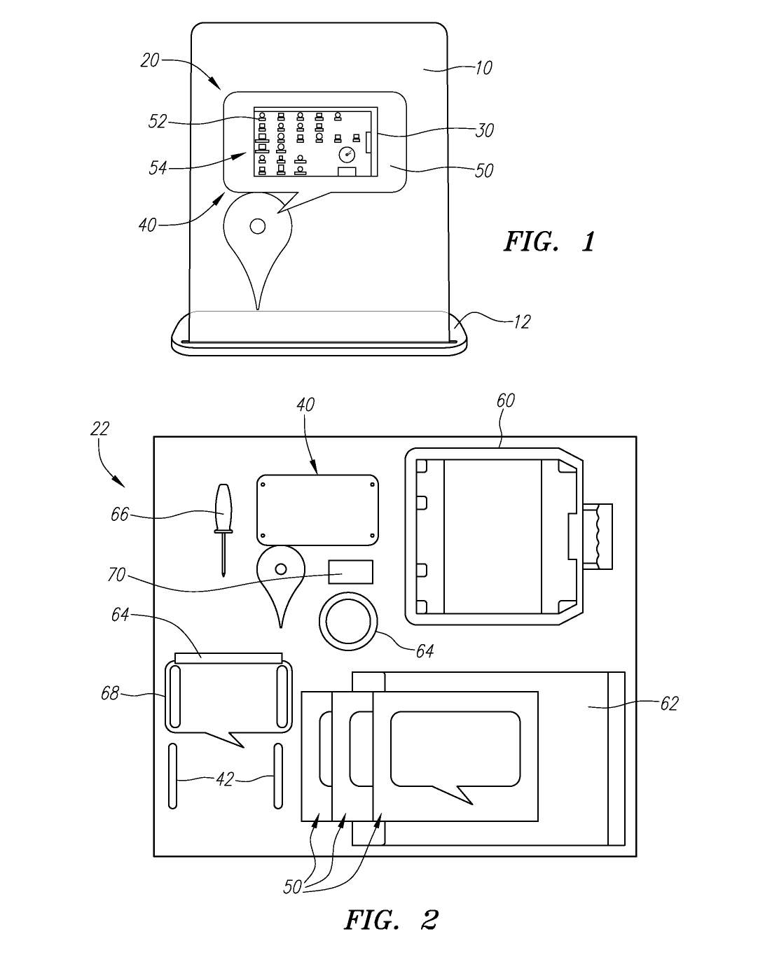

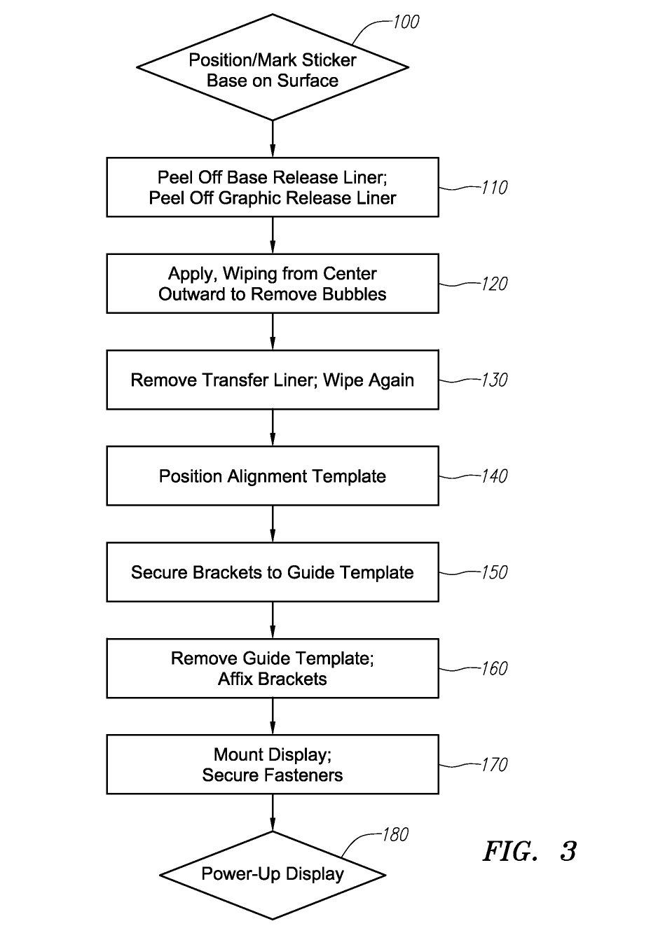

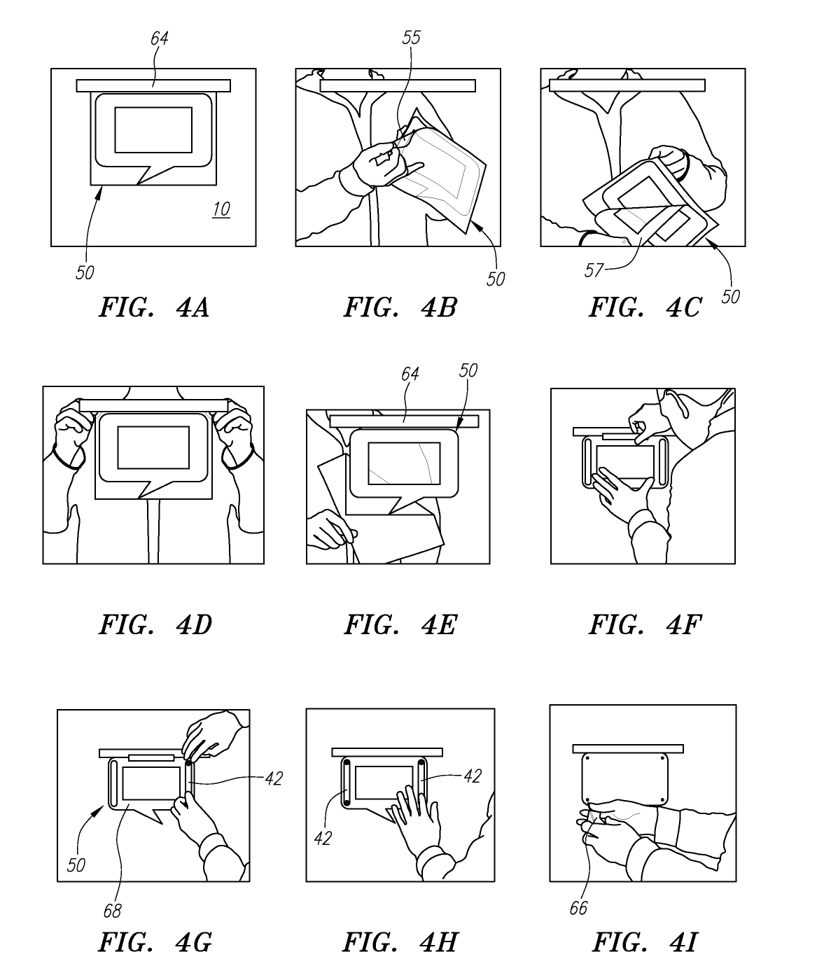

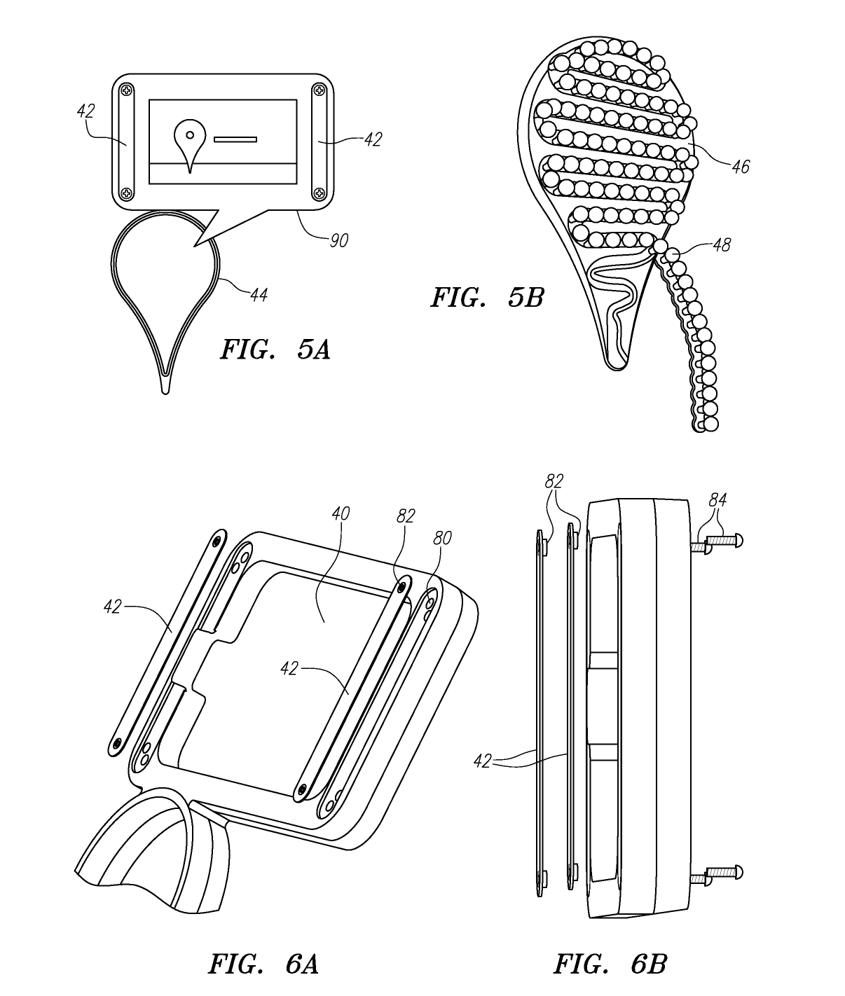

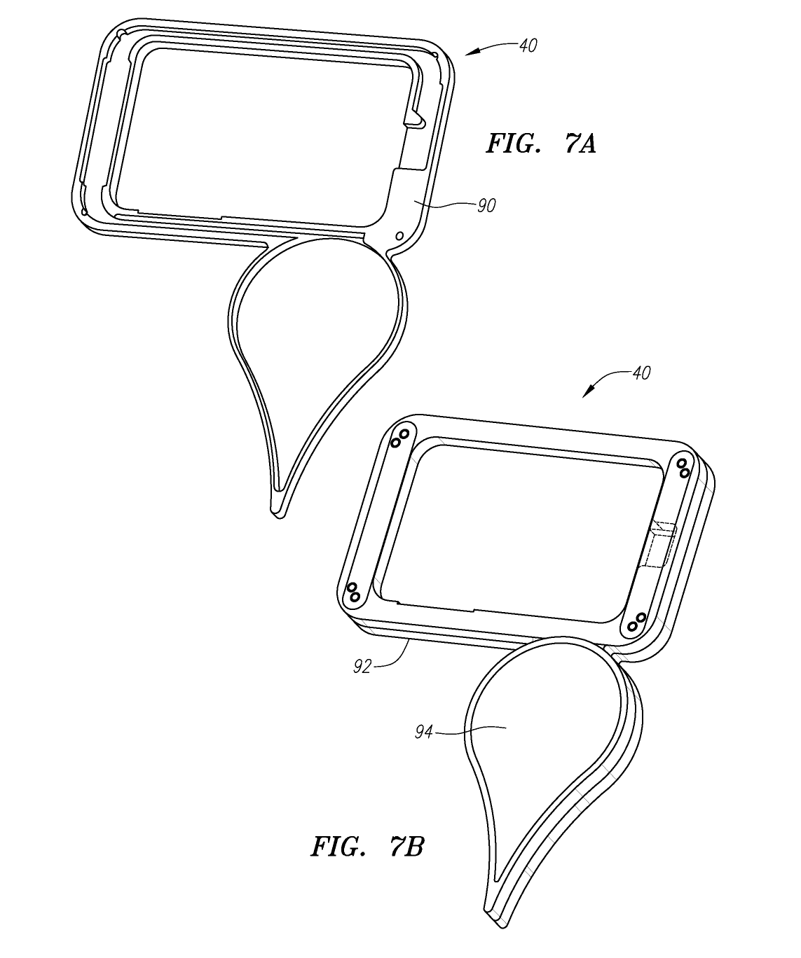

Accordingly, FIG. 1 illustrates an installed display system; FIG. 2 illustrates a kit including elements of one embodiment prior to device installation; FIG. 3 is a flowchart illustrating an approach; to such installation; FIGS. 4A-4I are photographs illustrating the step-by-step flowchart action; FIGS. 5A and 58 illustrate subcomponent assemblies for the display systems; FIGS. 6A and 68 are perspective and views illustrating frame and base-bracket element interface/interaction; and FIGS. 7A and 78 illustrate frame component assembly.

### DETAILED DESCRIPTION

FIG. 1 shows an interactive display system 20, mounted to a glass panel 10 held in a stand 12 (with the setup intended to model placement on a storefront window or the like). The device comprises a display 30 received in a frame 40 held to a base 50. The base comprises a flexible polymer film with a translucent portion 52 through which the display may be seen, and an opaque border 54 (white with black trim).

The system may be provided in a kit 22 including the various component and spares and associated tools and accessories. A case 60 is provided to house components. These optionally include an envelope or folio 62 for multiple base-element stickers, tape 64 and a screw driver for installing/removing screw or bolt fasteners, an alignment guide 68 and squeegee card 70 for smoothing out and removing bubbles when applying base 50. Frame 40 carries the display and fasteners inside for connecting the frame to runners/brackets 42.

FIG. 3 is a flowchart describing use of the kit. At 100, the intended position of the “sticker” base 50 is positioned marked on the surface to which it is to be applied (e.g., by a strip of tape 64). At 110 any base release liner 55 and graphics release liner 57 are peeled off. Then, at 120 base 50 is applied to the window surface and wiped (using squeegee 70) to remove bubbles and/or wrinkles. Next at 130 any transfer liner 59 is removed and base 50 is optionally wiped again.

At 140, alignment template 68 is positioned as a guide. Brackets 42 may be secured to the guide at 150. In any case, at 160 the guide is removed and the brackets are secured to the base—in this example—by applying pressure for adherence. At 170, the display frame is mounted, using the screw driver 66 to tighten fasteners at each of four corners of the device. Finally, the system may be powered-up for use at 180.

In FIGS. 4A-4I, the corresponding steps are readily matched-up given the action shown and numerals indicated. Further construction details may be appreciated in reference to the remaining figures.

FIGS. 5A and 5B illustrates various components and sub-components of system constriction. FIG. 5A shows frame 40 and brackets 42. The frame may include a graphics-defining boundary 44. A carrier 46 receives string-lights 48. Together, these are received within portion 44.

FIGS. 6A and 6B are perspective views illustrating the manner in which frame section 40 and base-bracket element 42 interface/interact. Through holes 80 are provided through frame to receive bolts 84. The bracket elements include threaded bosses 84 integrally formed therein for securing the bolts.

FIGS. 7A and 7B illustrate frame component assembly. In FIG. 7A a frame border 90, alone, is shown. An additional spacer 92 and cover elements 94 may be provided as well.

It is contemplated that any optional feature of the inventive variations described may be set forth and claimed independently, or in combination with any one or more of the features described herein. Reference to a singular item, includes the possibility that there is a plurality of the same items present: More specifically, as used herein and in the appended claims, the singular forms “a,” “an,” “said,” and “the” include plural referents unless specifically stated otherwise. In other words, use of the articles allow for “at least one” of the subject item in the description above as well as the claims below. Likewise, a matter described as “substantially” having some quality includes the possibility that it fully or completely possesses that quality. It is further noted that the claims may be drafted to exclude any optional element. As such, this statement is intended to serve as antecedent basis for use of such exclusive terminology as “solely,” “only,” “alone” and the like in connection with the recitation of claim elements, or use of any type of “negative” claim limitation.

Without the use of such exclusive terminology, the terms “comprising” and “including” in the claims shall allow for the inclusion of any additional element irrespective of whether a given number of elements are enumerated in the claim, or the addition of a feature could be regarded as transforming the nature of an element set forth in the claims. Except as specifically defined herein, all technical and scientific terms used herein are to be given as broad a commonly understood meaning as possible while maintaining claim validity.

The breadth of the present inventions are not to be limited to the examples provided and/or the subject specification, but rather only by the scope of the claim language. Use of the term “invention(s)” herein is not intended to limit the scope of the claims in any manner, Rather it should be recognized that the “invention” includes the many variations explicitly and implicitly described herein, including those variations that would be obvious to one of ordinary skill in the art upon reading the present specification. Further, it is not intended that any section or subsection of this specification (i.e., the Summary, Detailed Description, Abstract, Field of the Invention, etc.) be accorded special significance in describing the inventions relative to another or the claims. Any of the teachings presented in one section, may be applied to and/or incorporated in another. All references cited are incorporated by reference in their entirety. Although the foregoing invention has been described in detail for purposes of clarity of understanding, it is contemplated that certain modifications may be practiced within the scope of the claims to be made.

1. A display system comprising:
an electronic display;
a base adapted to be affixed by adhesive to a surface;
a frame receiving the display and held by at least one mechanical fastener to the base.

2. The system of claim 1, wherein the base is rigid.

3. The system of claim 1, wherein the base includes a metal bracket portion.

4. The system of claim 1, wherein the base comprises a flexible film.

5. The system of claim 4, wherein the base includes a release ply.

6. The system of claim 4, wherein the base includes a carrier,

7. The system of claim 1, wherein at least a portion of the base is transparent for viewing the display therethrough.

8. The system of claim 7, wherein a portion of the base is opaque.

9. The system of claim 7, wherein an opaque portion obscures the at least one fastener.

10. The system of claim 1, wherein the frame is rigid.

11. A method of installing a visual display system comprising:
acquiring a display system comprising an electronic display, a base adapted to be affixed by adhesive to a surface and a frame receiving the display;
adhering the base to a surface; and
securing the base to the frame with at least one mechanical fastener.

12. The method of claim 11, wherein the surface selected is a transparent window.

13. The method of claim 12, wherein the display system is installed at an indoor location and the display is visible outdoors.
